(19) United States
(12) Patent Application Publication
(10) Pub. No.: US 2018/0004531 A1
(43) Pub. Date: Jan. 4, 2018

(54) SPLIT CONTROL STACK AND DATA STACK PLATFORM

(71) Applicant: Microsoft Technology Licensing, LLC, Redmond, WA (US)

(72) Inventors: Ling Tony Chen, Bellevue, WA (US); Kenneth D. Johnson, Bellevue, WA (US); Jonathan E. Lange, Seattle, WA (US); Kinshumann, Redmond, WA (US); Matthew Miller, Seattle, WA (US); Neeraj Singh, Seattle, WA (US)

(73) Assignee: Microsoft Technology Licensing, LLC, Redmond, WA (US)

(21) Appl. No.: 15/199,399

(22) Filed: Jun. 30, 2016

(51) Int. Cl. G06F 9/38; G06F 3/06; G06F 9/30

(52) U.S. Cl. CPC G06F 9/3861; G06F 9/30032; G06F 3/0604; G06F 3/0631; G06F 3/0673

(57) ABSTRACT

In one example, a method includes allocating separate portions of memory for a control stack and a data stack. The method also includes, upon detecting a call instruction, storing a first return address in the control stack and a second return address in the data stack; and upon detecting a return instruction, popping the first return address from the control stack and the second return address from the data stack and raising an exception if the two return addresses do not match. Otherwise, the return instruction returns the first return address. Additionally, the method includes executing an exception handler in response to the return instruction detecting an exception, wherein the exception handler is to pop one or more return addresses from the control stack until the return address on a top of the control stack matches the return address on a top of the data stack.

### BACKGROUND

Many applications and operating systems store data in data structures such as stacks. A stack, as referred to herein, can include any data structure that stores data using a last-in first-out technique. For example, the last or most recent data stored in the stack is the first data to be removed from the stack. A stack can store information for an operating system or application using frames that store parameters, return addresses, and local variables for any number of processes and threads being executed.

In some examples, an operating system can handle exceptions based on data stored in one or more stacks. For example, an operating system can implement a shadow stack that stores data related to the execution of an application. In some techniques, the operating system may only store return addresses in the shadow stack and the operating system may handle an exception based on the return addresses stored in the shadow stack.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for managing a split stack platform, wherein the system includes memory and at least one processor configured to allocate separate portions of the memory for a control stack and a data stack of the split stack platform. The at least one processor can also be configured to, based at least on detecting a call instruction, store a first return address and a second return address in the control stack and the data stack, respectively. Additionally, the at least one processor can also, based at least on detecting a return instruction, pop the first return address from the control stack and the second return address from the data stack and raise an exception if the first and second return addresses do not match. In some examples, otherwise, the at least one processor can return to the first return address. In some embodiments, based at least on the first and the second return addresses not matching, the at least one processor can execute an exception handler in response to the exception from the return instruction, wherein the exception handler is configured to pop one or more return addresses from the control stack until the return address on a top of the control stack matches the return address on a top of the data stack. In some examples, the exception handler resumes to the return instruction and the return instruction returns to the return address that matches the top of the control stack and the top of the data stack. Furthermore, if the return addresses on the control stack are depleted before a match is found with the return address on the top of the data stack, the at least one processor can terminate a running program.

In another embodiment described herein, a method for managing a split stack platform includes allocating separate portions of the memory for a control stack and a data stack of the split stack platform. The method also includes, based at least on detecting a call instruction, storing a first return address and a second return address in the control stack and the data stack, respectively. Additionally, the method includes, based at least on detecting a return instruction, popping the first return address from the control stack and the second return address from the data stack and raising an exception if the first and second return addresses do not match. In some examples, otherwise, the method can return to the first return address. In some embodiments, based at least on the first and the second return addresses not matching, the method can execute an exception handler in response to the exception from the return instruction, wherein the exception handler is configured to pop one or more return addresses from the control stack until the return address on a top of the control stack matches the return address on a top of the data stack. In some examples, the exception handler resumes to the return instruction and the return instruction returns to the return address that matches the top of the control stack and the top of the data stack. Furthermore, if the return addresses on the control stack are depleted before a match is found with the return address on the top of the data stack, the method can terminate a running program.

In yet another embodiment described herein, one or more computer-readable storage devices for managing a split stack platform can include a plurality of instructions that, based at least on execution by a processor, cause the processor to allocate separate portions of the memory for a control stack and a data stack of the split stack platform. The plurality of instructions can also cause a processor to, based at least on detecting a call instruction, store a first return address and a second return address in the control stack and the data stack, respectively. Additionally, the plurality of instructions can also cause a processor to, based at least on detecting a return instruction, pop the first return address from the control stack and the second return address from the data stack and raise an exception if the first and second return addresses do not match. In some examples, otherwise, the plurality of instructions can also cause a processor to return to the first return address. In some embodiments, based at least on the first and the second return addresses not matching, the plurality of instructions can also cause a processor to execute an exception handler in response to the exception from the return instruction, wherein the exception handler is configured to pop one or more return addresses from the control stack until the return address on a top of the control stack matches the return address on a top of the data stack. In some examples, the exception handler resumes to the return instruction and the return instruction returns to the return address that matches the top of the control stack and the top of the data stack. Furthermore, if the return addresses on the control stack are depleted before a match is found with the return address on the top of the data stack, the plurality of instructions can also cause a processor to terminate a running program.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can split a control stack and data stack;

FIG. 2 is a block diagram illustrating a split control stack and data stack;

FIG. 3 is a process flow diagram of an example method for implementing a split control stack and data stack; and

FIG. 4 is a block diagram of an example computer-readable storage media that can implement a split control stack and data stack.

### DETAILED DESCRIPTION

In some examples, a CPU can handle return instructions based on data stored in one or more stacks. For example, a CPU may store the return address on a data stack during a CALL instruction, and later on return to that return address on the data stack during a return instruction. Alternatively, a CPU may support a split stack architecture where the return address is not only placed on the data stack but also placed on an additional control stack. On a CPU that implements split stack (a.k.a. shadow stack), the return instruction may choose to pop a return address from both data stack and control stack and compare whether they are equal. If equal, the return instruction returns to the return address, but when not equal, the return instruction may let a software exception handler deal with the discrepancy. Various functionalities of an exception handler are described herein.

In embodiments described herein, a system can implement a split control stack and data stack, in which the control stack and the data stack are stored in separate portions of memory. A control stack, as referred to herein, can include any suitable data structure that stores return addresses corresponding to a calling function. A data stack, as referred to herein, can include any suitable data structure that stores parameters for functions being executed by an application, return addresses for functions, and local variables for functions, among others. The system described herein can allocate separate portions of memory for a control stack and a data stack. For example, the system can store the control stack and the data stack in separate memory pages. The system can also, upon detecting a call instruction, store a return address in both the control stack and the data stack. In some embodiments, the system can, upon detecting a return instruction, pop the return address from both the control stack and the data stack and raise an exception if the two return addresses do not match. If the two return addresses do match, the return instruction can return to the matching return address.

In some embodiments, the system described herein can also execute an exception handler in response to the exception. In some embodiments, the exception handler can pop one or more return addresses from the control stack until the return address on top of the control stack matches the return address on top of the data stack. The exception handler can also resume to the return instruction, which can return to the return address that matches the top of the control stack and the top of the data stack. In some examples, if the return addresses on the control stack are depleted before a match is found with the return address on the top of the data stack, the exception handler can generate a fatal error and terminate a running program.

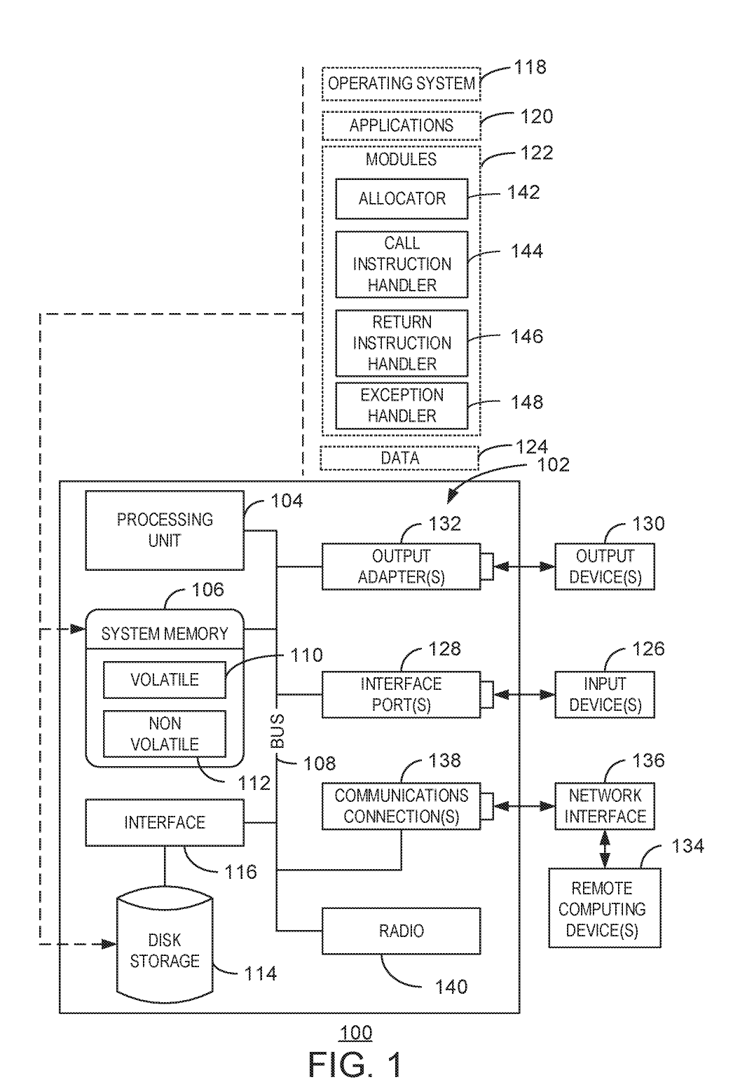

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 discussed below, provide details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that can implement a split control stack and data stack. The example system 100 includes a computing device 102. The computing device 102 includes a processing unit 104, a system memory 106, and a system bus 108. In some examples, the computing device 102 can be a gaming console, a personal computer (PC), an accessory console, a gaming controller, among other computing devices. In some examples, the computing device 102 can be a node in a cloud network.

The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structure, including the memory bus or memory controller, a peripheral bus or external bus, and a local bus using any variety of available bus architectures known to those of ordinary skill in the art. The system memory 106 includes computer-readable storage media that includes volatile memory 110 and nonvolatile memory 112.

The basic input/output system (BIOS), containing the basic routines to transfer information between elements within the computer 102, such as during start-up, is stored in nonvolatile memory 112. By way of illustration, and not limitation, nonvolatile memory 112 can include read-only memory (ROM), programmable ROM (PROM), electrically programmable ROM (EPROM), electrically erasable programmable ROM (EEPROM), or flash memory.

Volatile memory 110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 102 also includes other computer-readable media, such as removable/non-removable, volatile/non-volatile computer storage media. FIG. 1 shows, for example a disk storage 114. Disk storage 114 includes, but is not limited to, devices like a magnetic disk drive, floppy disk drive, tape drive, Jaz drive, Zip drive, LS-210 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer 102.

System applications 120 take advantage of the management of resources by operating system 118 through program modules 122 and program data 124 stored either in system memory 106 or on disk storage 114. It is to be appreciated that the disclosed subject matter can be implemented with various operating systems or combinations of operating systems.

A user enters commands or information into the computer 102 through input devices 126. Input devices 126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 126 connect to the processing unit 104 through the system bus 108 via interface ports 128. Interface ports 128 include, for example, a serial port, a parallel port, a game port, and a universal serial bus (USB).

Output devices 130 use some of the same type of ports as input devices 126. Thus, for example, a USB port may be used to provide input to the computer 102 and to output information from computer 102 to an output device 130.

Output adapter 132 is provided to illustrate that there are some output devices 130 like monitors, speakers, and printers, among other output devices 130, which are accessible via adapters. The output adapters 132 include, by way of illustration and not limitation, video and sound cards that provide a means of connection between the output device 130 and the system bus 108. It can be noted that other devices and systems of devices provide both input and output capabilities such as remote computing devices 134.

The computer 102 can be a server hosting various software applications in a networked environment using logical connections to one or more remote computers, such as remote computing devices 134. The remote computing devices 134 may be client systems configured with web browsers, PC applications, mobile phone applications, and the like. The remote computing devices 134 can be a personal computer, a server, a router, a network PC, a workstation, a microprocessor based appliance, a mobile phone, a peer device or other common network node and the like, and typically includes many or all of the elements described relative to the computer 102.

Remote computing devices 134 can be logically connected to the computer 102 through a network interface 136 and then connected via a communication connection 138, which may be wireless. Network interface 136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 138 refers to the hardware/software employed to connect the network interface 136 to the bus 108. While communication connection 138 is shown for illustrative clarity inside computer 102, it can also be external to the computer 102. The hardware/software for connection to the network interface 136 may include, for exemplary purposes, internal and external technologies such as, mobile phone switches, modems including regular telephone grade modems, cable modems and DSL modems, ISDN adapters, and Ethernet cards.

The computer 102 can further include a radio 140. For example, the radio 140 can be a wireless local area network radio that may operate one or more wireless bands. For example, the radio 140 can operate on the industrial, scientific, and medical (ISM) radio band at 2.4 GHz or 5 GHz. In some examples, the radio 140 can operate on any suitable radio band at any radio frequency.

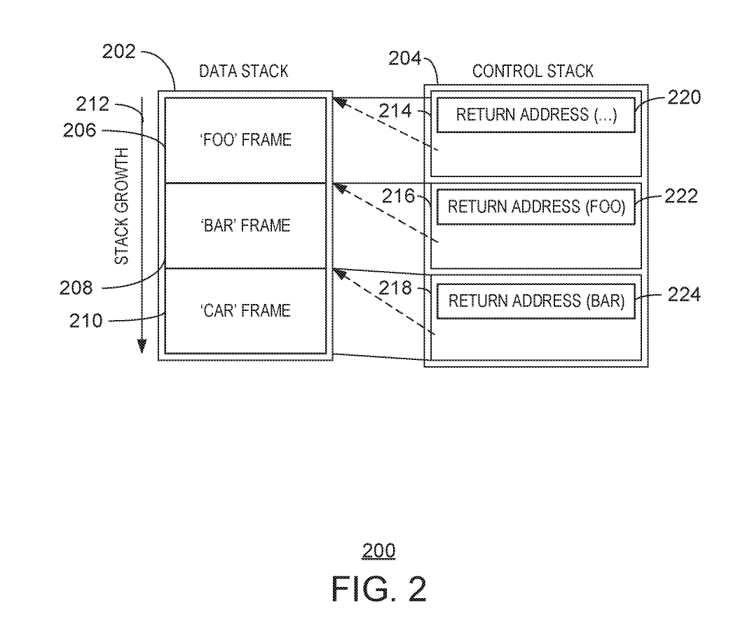

The computer 102 includes one or more modules 122, such as an allocator 142, a call instruction handler 144, a return instruction handler 146, and an exception handler, configured to enable implementing a split control stack and data stack. In some embodiments, the allocator 142 can allocate separate portions of memory for a control stack and a data stack. The control stack and data stack are described in greater detail below in relation to FIG. 2. In some embodiments, the call instruction handler 144 can store a return address in both the control stack and the data stack in response to detecting a call instruction. In some embodiments, the return instruction handler 146 can pop the return address from both the control stack and the data stack in response to detecting a return instruction.

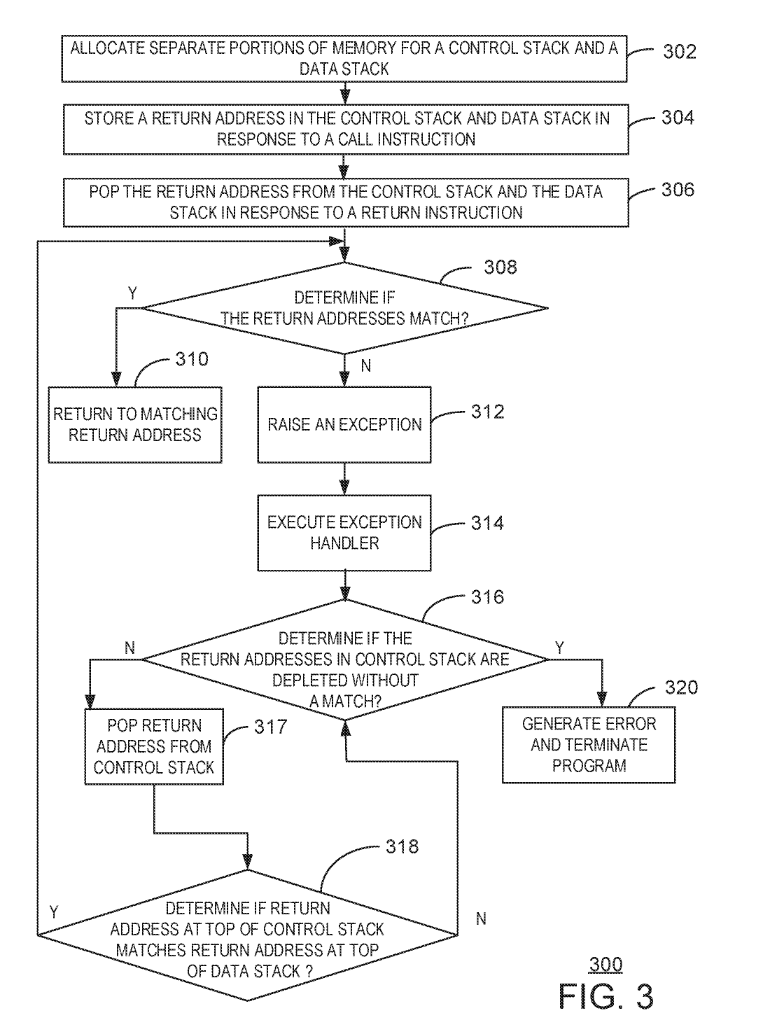

In some embodiments, the return instruction handler 146 can raise an exception if the two return addresses do not match. Raising an exception, as referred to herein, can include transferring execution into an exception handler module that tries to fix or resolve the problem or exception and then resumes execution of the return instruction. Alternatively, the return instruction handler 146 can return to the matching return address if the return addresses stored on top of the control stack and the data stack match. In some embodiments, an exception handler 148 can be executed in response to the return instruction detecting a mismatch between the return address on the control stack and the data stack. The exception handler 148 can pop one or more return addresses from the control stack until the return address on top of the control stack matches the return address on top of the data stack. This can help return the two separate stacks into a coherent state after a structured C/C++ exception happens as well as after instruction streams that execute the CALL+POP sequence. The exception handler 148 can also resume to the return instruction that called the exception handler 148 and the return instruction can return the return address that matches the top of the control stack and the top of the data stack. In some examples, if the return addresses on the control stack are depleted before a match is found with the return address on the top of the data stack, the exception handler 148 can generate a fatal error and terminate a running program. The management of the control stack and the data stack is described in greater detail below in relation to FIG. 3. In some embodiments, the call instruction handler 144 and the return instruction handler 146 can be implemented with any suitable hardware component.

It is to be understood that the block diagram of FIG. 1 is not intended to indicate that the computing system 102 is to include all of the components shown in FIG. 1. Rather, the computing system 102 can include fewer or additional components not illustrated in FIG. 1 (e.g., additional applications, additional modules, additional memory devices, additional network interfaces, etc.). Furthermore, any of the functionalities of the allocator 142, call instruction handler 144, return instruction handler 146, and exception handler 148 may be partially, or entirely, implemented in hardware and/or in the processor 104. For example, the functionality may be implemented with an application specific integrated circuit, in logic implemented in the processor 104, or in any other device.

FIG. 2 is a block diagram illustrating a control stack and a data stack. The split data stack 202 and control stack 204 can be implemented by any suitable computing device, such as the computing system 102 of FIG. 1.

The data stack 202 can include data for any suitable number of functions. For example, the data stack 202 includes frames 206, 208, and 210 corresponding to a foo function, a bar function, and a car function. Each frame 206, 208, and 210 of the data stack can include from top to bottom, variables passed to a function as parameters, a return address, and local variables, among others. For example, the bar frame 208 can include parameters passed to the bar function, a return address to the foo frame 206, and local variable for the bar function. The stack growth indicator 212 indicates that data for the most recent functions called or executed are stored on the lower portion of the stack as the data stack 202 grows in a downward direction. For example, FIG. 2 illustrates a scenario in which a foo function initiates a function call to a bar function, which initiates a function call to a car function. Thus, the car function is the most recently executed function and the frame 210 for the car function is located at the edge of the stack that will be removed first. In some examples, data for the most recent functions called can also be stored on top of a data stack that grows in an upward direction.

In some embodiments, the control stack 204 can include a return address for any number of functions being executed. For example, the control stack 204 can store a return address in any number of control frames. In FIG. 2, for example, the control stack 204 includes three control frames 214, 216, and 218 corresponding to the foo function control frame 206, bar function control frame 208, and car function control frame 210. Each control frame 214, 216, and 218 stores a return address 220, 222, or 224. Each return address 220, 222, or 224 corresponds to a return address stored in a corresponding data stack frame 206, 208, or 210. For example, return address 220 corresponds to a return address stored in the data stack frame for the foo function 206. The return address 220, 222, or 224 stored in each control frame 216, 218, or 220 of the control stack 204 can be set to the address of the instruction following the call instruction. In some embodiments, storing a return address in each control stack frame can enable multi-level returns. A multi-level return, as referred to herein, can include a return address corresponding to any nested function calls, recursive function calls, and the like.

It is to be understood that the block diagram of FIG. 2 is not intended to indicate that the data stack 202 and the control stack 204 are include all of the information shown in FIG. 2. Rather, the data stack 202 and the control stack 204 can include fewer or additional frames and data values not illustrated in FIG. 2.

FIG. 3 is a process flow diagram illustrating a method for implementing a split control stack and data stack. The method 300 can be implemented with any suitable computing device, such as the computing system 102 of FIG. 1.

At block 302, an allocator 142 can allocate separate portions of memory for a control stack and a data stack. In some embodiments, the control stack and the data stack can each be stored in separate memory pages. The allocator 142 can initialize the control stack for a task or thread by allocating, via an operating system, a region of virtual memory that will be used as a task or thread's control stack. In some examples, the memory used to store the control stack may not be committed initially. Rather, the allocator 142 can allocate a reserved region of memory to store the control stack and commit the initial memory page in the reserved region. To enable growth of the control stack, the allocator 142 can implement a guard page that can trigger a memory range exception that the operating system can detect and determine to commit the next memory page in the control stack. In some embodiments, the allocator 142 can initialize the first control frame of the control stack and set the initial value of the return address corresponding to a task. In some embodiments, the first control stack frame is a symbolic frame that sets the return address field to zero, which indicates an invalid control stack frame. By supporting demand growth of the control stack, the concerns regarding the amount of memory used to store the control stack are minimized as the actual requirements on committed memory are managed per the needs of the application being executed.

In some embodiments, the allocator 142 can protect the contents of the control stack from unauthorized accesses by preventing a task from directly writing to the control stack or changing a virtual to physical mapping of the control stack. As referenced above, in some examples, the allocator 142 can use a guard page to enable dynamic growth of the control stack. In some embodiments, during thread termination, the allocator 142 can free the memory region that was allocated for a control stack.

At block 304, a call instruction handler 144 can store a return address in both the control stack and the data stack in response to detecting a call instruction. In some embodiments, the call instruction handler 144 can store a return address in the control stack and the data stack for any number of call instructions. The call instruction handler 144 may store each return address on a top of the data stack and the control stack. A top of a stack, as referred to herein, indicates the most recently stored information in the stack.

At block 306, a return instruction handler 146 can, in response to detecting a return instruction, pop the return address from both the control stack and the data stack. Popping, as referred to herein, includes removing or deleting the most recently stored data values at the top of a stack. In some embodiments, the return instruction enables execution of a legacy application. At block 308, the return instruction handler 146 can determine if the return address on top of the control stack and the top of the data stack match. If the return addresses match, the process flow continues at block 310. If the return addresses do not match, the process flow continues at block 312.

At block 310, the return instruction handler 146 can detect that the return addresses on top of the data stack and the control stack match, and the return instruction handler 146 can return to the matching return address. In some examples, the return address corresponds to runtime instructions for a task, application, or thread being executed by an operating system.

At block 312, the return instruction handler 146 can raise an exception if the two return addresses from the data stack and the control stack do not match. As discussed above, raising an exception can include transferring control to an exception handler.

At block 314, an exception handler 148 can be executed in response to detecting the exception. At block 316, the exception handler 148 determines if return addresses in the control stack are depleted without matching a return address on top of the data stack. If the exception handler 148 does deplete the control stack without a matching return address, the process flow continues at block 320 by generating an error and terminating the executing program. If the exception handler 148 detects the control stack is not depleted, the process flow continues at block 317. At block 317, the exception handler 148 can pop one or more return addresses from the control stack. At block 318, the exception handler 148 can determine if the return address at the top of the control stack matches the return address at the top of the data stack. If the return addresses match, the process flow returns to block 308. If the return addresses do not match, the process flow returns to block 316.

In one embodiment, the process flow diagram of FIG. 3 is intended to indicate that the steps of the method 300 are to be executed in a particular order. Alternatively, in other embodiments, the steps of the method 300 can be executed in any suitable order and any suitable number of the steps of the method 300 can be included. Further, any number of additional steps may be included within the method 300, depending on the specific application. For example, in some embodiments, the exception handler 148 can generate a kernel application programming interface to enable runtime instructions to set one or more data values indicating one or more registered interception routines that replace the return addresses on the data stack. In some examples, the process exception handler can detect the return address on the data stack matches one of the registered interception routines and update the return address on the control stack to be equal to the return address on the data stack. The exception handler 148 can also resume the return instruction to return the updated return address.

Furthermore, in some embodiments, the exception handler 148 can detect that a return instruction corresponds to a legacy binary and allow the exception resulting from the return addresses stored in the data stack and the control stack having different values. For example, the exception handler 148 can detect that the return instruction corresponds to the legacy binary based on a split stack register indicating the control stack and the data stack split is disabled.

In some embodiments, a system can use or maintain a bitmap or page table modifications to describe the set of memory pages that correspond to the control stack. In some examples, the bitmap can be encoded in memory management unit page tables. In some embodiments, the memory MOVE instruction can be changed to not allow moving data into the control stack. The CALL instruction is still allowed to move data into the control stack. In some examples, a system can also verify that the control stack being switched to contains a marker that identifies the memory page as a control stack. This marker can be stored at the top of the control stack when a control stack is “out-swapped” and then verified when the control stack is “in-swapped”.

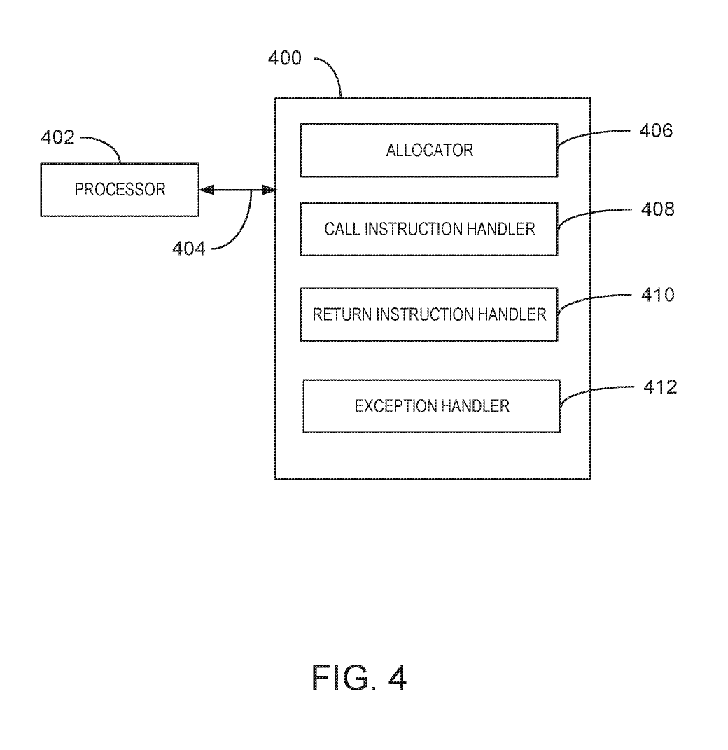

FIG. 4 is a block diagram of an example computer-readable storage media that can implement a split control stack and data stack. The tangible, computer-readable storage media 400 may be accessed by a processor 402 over a computer bus 404. Furthermore, the tangible, computer-readable storage media 400 may include code to direct the processor 402 to perform the steps of the current method.

The various software components discussed herein may be stored on the tangible, computer-readable storage media 400, as indicated in FIG. 4. For example, the tangible computer-readable storage media 400 can include an allocator 406, a call instruction handler 408, a return instruction handler 410, and an exception handler 412. In some embodiments, the allocator 406 can allocate separate portions of memory for a control stack and a data stack. In some embodiments, the call instruction handler 408 can store a return address in both the control stack and the data stack in response to detecting a call instruction. In some embodiments, the return instruction handler 410 can pop the return address from both the control stack and the data stack in response to detecting a return instruction. In some embodiments, the return instruction handler 410 can raise an exception if the two return addresses do not match. Alternatively, the return instruction handler 410 can return to the matching return address if the return addresses stored on top of the control stack and the data stack do match. In some embodiments, an exception handler 412 can be executed in response to the return instruction detecting a mismatch between the return address on the control stack and the data stack. The exception handler 412 can pop one or more return addresses from the control stack until the return address on top of the control stack matches the return address on top of the data stack. The exception handler 412 can also resume to the return instruction that called the exception handler 412 and the return instruction can return the return address that matches the top of the control stack and the top of the data stack. In some examples, if the return addresses on the control stack are depleted before a match is found with the return address on the top of the data stack, the exception handler 412 can generate a fatal error and terminate a running program.

It is to be understood that any number of additional software components not shown in FIG. 4 may be included within the tangible, computer-readable storage media 400, depending on the specific application.

### Example 1

In some embodiments, a system for managing a split stack platform includes memory and at least one processor configured to allocate separate portions of the memory for a control stack and a data stack of the split stack platform. The at least one processor can also be configured to, based at least on detecting a call instruction, store a first return address and a second return address in the control stack and the data stack, respectively. Additionally, the at least one processor can also, based at least on detecting a return instruction, pop the first return address from the control stack and the second return address from the data stack and raise an exception if the first and second return addresses do not match. In some examples, otherwise, the at least one processor can return to the first return address. In some embodiments, based at least on the first and the second return addresses not matching, the at least one processor can execute an exception handler in response to the exception from the return instruction, wherein the exception handler is configured to pop one or more return addresses from the control stack until the return address on a top of the control stack matches the return address on a top of the data stack. In some examples, the exception handler resumes to the return instruction and the return instruction returns to the return address that matches the top of the control stack and the top of the data stack. Furthermore, if the return addresses on the control stack are depleted before a match is found with the return address on the top of the data stack, the at least one processor can terminate a running program.

In some embodiments, the at least one processor is to generate a fatal error. Alternatively, or in addition, the at least one processor can generate a kernel application programming interface to enable runtime instructions to set one or more data values indicating one or more registered interception routines that replace the second return address on the data stack. Alternatively, or in addition, the process exception handler can detect if the second return address on the data stack matches one of the registered interception routines; and if so, the exception handler updates the first return address on the control stack to be equal to the second return address on the data stack, and resumes the return instruction to return to the updated first return address. Alternatively, or in addition, the at least one processor can maintain a bitmap indicating a plurality of locations of memory pages corresponding to a location of the control stack. Alternatively, or in addition, the at least one processor can prevent a move instruction from directly modifying the control stack based on the bitmap. Alternatively, or in addition, the at least one processor can maintain memory locations of legacy code, and the exception handler is to detect whether the system is returning from legacy code, and if so, the at least one processor updates the first return address on the control stack to be equal to the second return address on the data stack, and resumes the return instruction to return to the updated first return address. In some embodiments, popping the first return address from the control stack and the second return address from the data stack comprises removing or deleting a most recently stored data value at the top of the control stack or the top of the data stack. In some embodiments, raising the exception comprises transferring execution into the exception handler that attempts to resolve the exception and resume execution of the return instruction.

### Example 2

In another embodiment described herein, a method for managing a split stack platform includes allocating separate portions of the memory for a control stack and a data stack of the split stack platform. The method also includes, based at least on detecting a call instruction, storing a first return address and a second return address in the control stack and the data stack, respectively. Additionally, the method includes, based at least on detecting a return instruction, popping the first return address from the control stack and the second return address from the data stack and raising an exception if the first and second return addresses do not match. In some examples, otherwise, the method can return to the first return address. In some embodiments, based at least on the first and the second return addresses not matching, the method can execute an exception handler in response to the exception from the return instruction, wherein the exception handler is configured to pop one or more return addresses from the control stack until the return address on a top of the control stack matches the return address on a top of the data stack. In some examples, the exception handler resumes to the return instruction and the return instruction returns to the return address that matches the top of the control stack and the top of the data stack. Furthermore, if the return addresses on the control stack are depleted before a match is found with the return address on the top of the data stack, the method can terminate a running program.

In some embodiments, the method includes generating a fatal error. Alternatively, or in addition, the method includes generating a kernel application programming interface to enable runtime instructions to set one or more data values indicating one or more registered interception routines that replace the second return address on the data stack. Alternatively, or in addition, the process exception handler can detect if the second return address on the data stack matches one of the registered interception routines; and if so, the exception handler updates the first return address on the control stack to be equal to the second return address on the data stack, and resumes the return instruction to return to the updated first return address. Alternatively, or in addition, the method includes maintaining a bitmap indicating a plurality of locations of memory pages corresponding to a location of the control stack. Alternatively, or in addition, the method includes preventing a move instruction from directly modifying the control stack based on the bitmap. Alternatively, or in addition, the method includes maintaining memory locations of legacy code, and the exception handler is to detect whether the system is returning from legacy code, and if so, the method updates the first return address on the control stack to be equal to the second return address on the data stack, and resumes the return instruction to return to the updated first return address. In some embodiments, popping the first return address from the control stack and the second return address from the data stack comprises removing or deleting a most recently stored data value at the top of the control stack or the top of the data stack. In some embodiments, raising the exception comprises transferring execution into the exception handler that attempts to resolve the exception and resume execution of the return instruction.

### Example 3

In yet another embodiment described herein, one or more computer-readable storage devices for managing a split stack platform can include a plurality of instructions that, based at least on execution by a processor, cause the processor to allocate separate portions of the memory for a control stack and a data stack of the split stack platform. The plurality of instructions can also cause a processor to, based at least on detecting a call instruction, store a first return address and a second return address in the control stack and the data stack, respectively. Additionally, the plurality of instructions can also cause a processor to, based at least on detecting a return instruction, pop the first return address from the control stack and the second return address from the data stack and raise an exception if the first and second return addresses do not match. In some examples, otherwise, the plurality of instructions can also cause a processor to return to the first return address. In some embodiments, based at least on the first and the second return addresses not matching, the plurality of instructions can also cause a processor to execute an exception handler in response to the exception from the return instruction, wherein the exception handler is configured to pop one or more return addresses from the control stack until the return address on a top of the control stack matches the return address on a top of the data stack. In some examples, the exception handler resumes to the return instruction and the return instruction returns to the return address that matches the top of the control stack and the top of the data stack. Furthermore, if the return addresses on the control stack are depleted before a match is found with the return address on the top of the data stack, the plurality of instructions can also cause a processor to terminate a running program.

In some embodiments, the plurality of instructions can cause the processor to generate a fatal error. Alternatively, or in addition, the plurality of instructions can cause the processor to generate a kernel application programming interface to enable runtime instructions to set one or more data values indicating one or more registered interception routines that replace the second return address on the data stack. Alternatively, or in addition, the process exception handler can detect if the second return address on the data stack matches one of the registered interception routines; and if so, the exception handler updates the first return address on the control stack to be equal to the second return address on the data stack, and resumes the return instruction to return to the updated first return address. Alternatively, or in addition, the plurality of instructions can cause the processor to maintain a bitmap indicating a plurality of locations of memory pages corresponding to a location of the control stack. Alternatively, or in addition, the plurality of instructions can cause the processor to prevent a move instruction from directly modifying the control stack based on the bitmap. Alternatively, or in addition, the plurality of instructions can cause the processor to maintain memory locations of legacy code, and the exception handler is to detect whether the system is returning from legacy code, and if so, the processor updates the first return address on the control stack to be equal to the second return address on the data stack, and resumes the return instruction to return to the updated first return address. In some embodiments, popping the first return address from the control stack and the second return address from the data stack comprises removing or deleting a most recently stored data value at the top of the control stack or the top of the data stack. In some embodiments, raising the exception comprises transferring execution into the exception handler that attempts to resolve the exception and resume execution of the return instruction.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for managing a split stack platform, the system comprising:
memory; and
at least one processor configured to:
allocate separate portions of the memory for a control stack and a data stack of the split stack platform;
based at least on detecting a call instruction, store a first return address and a second return address in the control stack and the data stack, respectively;
based at least on detecting a return instruction, pop the first return address from the control stack and the second return address from the data stack and raise an exception if the first and second return addresses do not match, otherwise, return to the first return address; and
based at least on the first and the second return addresses not matching, execute an exception handler in response to the exception from the return instruction, wherein the exception handler is configured to:
pop one or more return addresses from the control stack until the return address on a top of the control stack matches the return address on a top of the data stack, wherein the exception handler resumes to the return instruction and the return instruction returns to the return address that matches the top of the control stack and the top of the data stack; and
if the return addresses on the control stack are depleted before a match is found with the return address on the top of the data stack, terminate a running program.

2. The system of claim 1, wherein the at least one processor is to generate a fatal error.

3. The system of claim 1, wherein the at least one processor is to generate a kernel application programming interface to enable runtime instructions to set one or more data values indicating one or more registered interception routines that replace the second return address on the data stack.

4. The system of claim 3, wherein the process exception handler is to detect if the second return address on the data stack matches one of the registered interception routines; and if so, the exception handler updates the first return address on the control stack to be equal to the second return address on the data stack, and resumes the return instruction to return to the updated first return address.

5. The system of claim 1, wherein the at least one processor is to maintain a bitmap indicating a plurality of locations of memory pages corresponding to a location of the control stack.

6. The system of claim 5, wherein the at least one processor is to prevent a move instruction from directly modifying the control stack based on the bitmap.

7. The system of claim 1, wherein the at least one processor is to maintain memory locations of legacy code, and the exception handler is to detect whether the system is returning from legacy code, and if so, the at least one processor updates the first return address on the control stack to be equal to the second return address on the data stack, and resumes the return instruction to return to the updated first return address.

8. The system of claim 1, wherein popping the first return address from the control stack and the second return address from the data stack comprises removing or deleting a most recently stored data value at the top of the control stack or the top of the data stack.

9. The system of claim 1, wherein raising the exception comprises transferring execution into the exception handler that attempts to resolve the exception and resume execution of the return instruction.

10. A method for managing a split stack platform comprising:
allocating separate portions of the memory for a control stack and a data stack of the split stack platform;
based at least on detecting a call instruction, storing a first return address in the control stack and a second return address in the data stack;
based at least on detecting a return instruction, popping the first return address from the control stack and the second return address from the data stack and raising an exception if the first return address and the second return address do not match, otherwise returning to the first return address; and
based at least on the first and the second return addresses not matching, executing an exception handler, wherein the exception handler is configured to:
pop one or more return addresses from the control stack until the return address on a top of the control stack matches the return address on a top of the data stack, wherein the exception handler resumes to the return instruction and the return instruction returns to the return address that matches the top of the control stack and the top of the data stack; and
if the return addresses on the control stack are depleted before a match is found with the return address on the top of the data stack, terminate a running program.

11. The method of claim 10, comprising generating a fatal error.

12. The method of claim 10, comprising generating a kernel application programming interface to enable runtime instructions to set one or more data values indicating one or more registered interception routines that replace the second return address on the data stack.

13. The method of claim 12, comprising detecting if the second return address on the data stack matches one of the registered interception routines; and, if so, updating the first return address on the control stack to be equal to the second return address on the data stack, and resuming the return instruction to return to the updated first return address.

14. The method of claim 10, comprising maintaining a bitmap indicating a plurality of locations of memory pages corresponding to a location of the control stack.

15. The method of claim 14, comprising preventing a move instruction from directly modifying the control stack based on the bitmap.

16. One or more computer-readable storage devices for managing a split stack platform comprising a plurality of instructions that, based at least on execution by a processor, cause the processor to:
allocate separate portions of the memory for a control stack and a data stack of the split stack platform;
based at least on detecting a call instruction, store a first return address in the control stack and a second return address in the data stack;
based at least on detecting a return instruction, pop the first return address from the control stack and the second return address from the data stack and raise an exception if the first return address and the second return address do not match, otherwise return to the first return address; and
based at least on the first and the second return addresses not matching, execute an exception handler, wherein the exception handler is configured to:
pop one or more return addresses from the control stack until the return address on a top of the control stack matches the return address on a top of the data stack, wherein the exception handler resumes to the return instruction and the return instruction returns to the return address that matches the top of the control stack and the top of the data stack; and
if the return addresses on the control stack are depleted before a match is found with the return address on the top of the data stack, terminate a running program.

17. The one or more computer-readable storage devices of claim 16, wherein the plurality of instructions cause the processor to generate an error.

18. The one or more computer-readable storage devices of claim 16, wherein the plurality of instructions cause the processor to generate a kernel application programming interface to enable runtime instructions to set one or more data values indicating one or more registered interception routines that replace the second return address on the data stack.

19. The one or more computer-readable storage devices of claim 18, wherein the process exception handler is to detect if the second return address on the data stack matches one of the registered interception routines; and, if so, update the first return address on the control stack to be equal to the second return address on the data stack, and resume the return instruction to return to the updated first return address.

20. The one or more computer-readable storage devices of claim 16, wherein the plurality of instructions cause the processor to maintain a bitmap indicating a plurality of locations of memory pages corresponding to a location of the control stack.
